(19) United States
(12) Patent Application Publication
(10) Pub. No.: US 2007/0080320 A1
(43) Pub. Date: Apr. 12, 2007

(54) Liquid Cure Promoter Compositions With Suppressed Solids Forming Tendencies and Their Uses

(75) Inventor: Wenfeng Kuang, Baton Rouge, LA (US)

Correspondence Address: Albemarle Corporation, 451 Florida Street, Baton Rouge, LA, 70801-1765, US

(73) Assignee: ALBEMARLE CORPORATION, Baton Rouge, LA (US)

(21) Appl. No.: 11/533,055

(22) Filed: Sep. 19, 2006

Related U.S. Application Data
(60) Provisional application No. 60/724,968, filed on Oct. 7, 2005.

(51) Int. Cl. C09K 3/00

(52) U.S. Cl. 252/182.13

(57) ABSTRACT

This invention provides a cure promoter composition with suppressed solids forming tendencies. This composition is formed from components which prior to use in forming the composition are comprised of: a) a major amount of N-methyl-N-(2-hydroxyethyl)-p-toluidine or N,N-bis(2-hydroxyethyl)-p-toluidine, or both; and b) a minor solids formation suppressing amount of at least one liquid fully-esterified phosphate ester having at least two, and preferably three, aryl ester groups and one or two phosphorus atoms in the molecule.

### REFERENCE TO RELATED APPLICATION

This application claims the benefit and priority of U.S. Provisional Application No. 60/724,968, filed Oct. 7, 2005, the disclosure of which is incorporated herein by reference.

### TECHNICAL FIELD

This invention relates to keeping specified liquid polymerization promoters free of solids formation at lower temperatures and/or for longer periods of time at room temperatures than temperatures or time periods at which solids normally tend to form therein.

### BACKGROUND

N-methyl-N-(2-hydroxyethyl)-p-toluidine and N,N-bis(2-hydroxyethyl)-p-toluidine are known cure promoters. See for example U.S. Pat. Nos. 6,114,470; 6,258,894; and 6,774,193, the entire disclosures of which are incorporated herein by reference. As produced, these compounds are liquids. Unfortunately however, during storage or transportation these compounds typically undergo solids formation. At about room temperatures solids formation can occur in a matter of hours, and at lower temperatures the rate at which solids formation occurs is increased. As between the two cure promoters, solids formation in N,N-bis(2-hydroxyethyl)-p-toluidine tends to occur sooner than in N-methyl-N-(2-hydroxyethyl)-p-toluidine.

A need thus exists for a way of suppressing the solids forming tendencies of these compounds, e.g., by keeping these compounds in the liquid state at lower temperatures and/or at room temperatures for longer periods of time. In doing so, it is important to ensure that the effectiveness of these compounds as cure promoters is not impaired to any unacceptable extent. It is also important to ensure that the properties of formulations in which these cure promoters are utilized are not impaired to any unacceptable extent.

### BRIEF SUMMARY OF THE INVENTION

This invention provides a way of satisfying the above need without impairing to any material extent the effectiveness of these compounds as cure promoters or the properties of formulations in which these cure promoters can be utilized.

Pursuant to this invention there is provided a cure promoter composition with suppressed solids formation tendencies, i.e., a depressed solids formation temperature and/or increased resistance to solids formation at room temperatures, which composition is formed from components which prior to use in forming the composition are comprised of:
a) a major amount of N-methyl-N-(2-hydroxyethyl)-p-toluidine or N,N-bis(2-hydroxyethyl)-p-toluidine, or both; and
b) a minor solids-suppressing amount of at least one liquid fully-esterified phosphate ester having at least two, and preferably three, aryl ester groups and one or two phosphorus atoms in the molecule.
   For convenience, the phosphate ester(s) used pursuant to this invention will often be referred to hereinafter as phosphate ester(s). By “a major amount” is meant more than 50 wt % of the combination of components a) and b) in the composition. Thus a minor amount is an amount that is less than 50 wt %.

Preferably the cure promoter compositions of this invention as formed are in the solids-free liquid state. However, as formed, they can be in the form of solids or solids-containing liquids and converted into a solids-free liquid state by heating to a mild temperature typically in the range of about 35 to about 45° C.

Methods of carrying out various curing operations or steps involved in such operations with the compositions of this invention are also provided by this invention.

The above and other features or embodiments of this invention will be still further apparent from the ensuing description and appended claims.

### FURTHER DETAILED DESCRIPTION OF THIS INVENTION

N-Methyl-N-(2-hydroxyethyl)-p-toluidine and N,N-bis(2-hydroxyethyl)-p-toluidine can be prepared by methods known in the art. For example, N-methyl-N-(2-hydroxyethyl)-p-toluidine can be prepared by adding a slight molar excess of ethylene oxide to N-methyl-p-toluidine and subjecting the mixture to conditions sufficient to ethoxylate the nitrogen atom of the N-methyl-p-toluidine. Another method which can be used to prepare N-methyl-N-(2-hydroxyethyl)-p-toluidine involves alkylating N-(2-hydroxyethyl)-p-toluidine using formaldehyde and hydrogen in the presence of palladium on carbon catalyst under suitable temperature and pressure conditions. N,N-bis(2-hydroxyethyl)-p-toluidine can be prepared from p-toluidine and 2-chloroethanol using alkylation conditions described for example in CS 171619 (Oct. 10, 1976) or in JP Kokai 03/181447 (Aug. 7, 1991).

When using a mixture N-methyl-N-(2-hydroxyethyl)-p-toluidine and N,N-bis(2-hydroxyethyl)-p-toluidine these compounds can be present in any proportions relative to each other, i.e., ranging from a trace of one to a trace of the other.

The phosphate ester(s) used in the practice of this invention are one or more liquid fully-esterified phosphate ester having at least two, and preferably three, aryl ester groups and one or two phosphorus atoms in the molecule. Typically, such phosphate ester(s) will have phosphorus content in the range of about 5 to about 15 wt %, and preferably in the range of about 7 to about 11 wt %. The phosphate ester(s) having one phosphorus atom per molecule used in this invention contain (i) two aryl ester groups and one alkyl ester group or (ii) preferably three aryl ester groups per molecule. The phosphate esters having two phosphorus atoms per molecule (biphosphate esters) used in this invention contain (i) 4 aryl ester groups (—OAr) and one arylene diester group (—ORO—) or (ii) 6 aryl ester groups per molecule. As indicated, mixtures of two or more different phosphate esters having one phosphorus atom per molecule, mixtures of two or more different phosphate esters having two phosphorus atoms per molecule, or mixtures of one or more phosphate esters having one phosphorus atom per molecule and one or more phosphate esters having two phosphorus atoms per molecule can be used.

The phosphate ester(s) used in the practice of this invention having one phosphorus atom per molecule are depicted by the general formula
(ArO)ₓP(O)(OR)_{y}
where each Ar is independently an aryl group, each R is independently an aryl or alkyl group, and x is 1-3 and y is 0-2, the sum of x and y being 3. Such phosphate ester(s) can be in admixture with triaryl phosphate, diaryl alkyl phosphate, or trialkyl phosphate provided that the resultant mixture is a liquid at ambient room temperatures. Preferred compounds of this group are triaryl phosphates, i.e., those in which x is 3 and y is 0. Of these, triaryl phosphates having a phosphorus content in the range of about 6.5 to about 9.5 wt % are generally more preferred.

The phosphate ester(s) used in the practice of this invention having two phosphorus atoms per molecule are depicted by the general formula
(ArO)₂P(O)(ORO)P(O)(OAr)₂
wherein each Ar is independently an aryl group, R is an arylene group. Such phosphate ester(s) can be in admixture with a triaryl phosphate or a diaryl alkyl phosphate (or both) provided that the resultant mixture is a liquid at ambient room temperatures. Preferred arylene groups, (—R—), in these compounds are either a phenylene group (meta or para) or a phenyleneoxyphenylene group, (-Ph-O-Ph-). Of these biphosphate ester(s), those with a phosphorus content in the range of about 8.5 to about 11.0 wt % are generally more preferred.

In the above formulas the total carbon content of the phosphate ester(s) is not critical provided that the product is in the liquid state at ambient room temperatures (and preferably at temperatures below ambient room temperatures).

Non-limiting examples of phosphate ester(s) which can be used in the practice of this invention, either singly or in mixtures, include di(methyl)(phenyl)phosphate, (cresyl)di(phenyl)phosphate, tri(cresyl)phosphate, tri(xylyl)phosphate, (isopropylphenyl)-di(phenyl)phosphate, di(isopropylphenyl)(phenyl)phosphate, (tert-butylphenyl)di(phenyl)-phosphate, di(tert-butylphenyl)(phenyl)phosphate, (2-ethylhexyl)di(phenyl)phosphate, (isodecyl)di(phenyl)phosphate, resorcinolbis[di(phenyl)phosphate], and bisphenol-A-bis[di(phenyl)phosphate].

Particularly preferred for use as component b) in the practice of this invention are liquid isopropylated triphenyl phosphates. Of these, isopropylated triphenyl phosphates having a phosphorus content in the range of about 7 to about 9 wt % and/or an average molecular weight in the range of about 300 to about 500 are especially desirable. Viscosities of such liquid isopropylated triphenyl phosphates can vary widely. For example, isopropylated triphenyl phosphates having an average molecular weight in the range of about 360 to about 500 and a viscosity at 25° C. in the range of about 52 to about 100 cSt are desirable, especially for use with N-methyl-N-(2-hydroxyethyl)-p-toluidine. Also especially desirable, especially for use with N,N-bis(2-hydroxyethyl)-p-toluidine, are isopropylated triphenyl phosphates having an average molecular weight in the range of about 300 to about 500 and a viscosity at 25° C. in the range of about 40 to about 100 cSt. Among such particularly preferred isopropylated triphenyl phosphates are products b)1, b)2, and b)3 having typical properties set forth in Table 1.

TABLE 1

| Product | b)1 | b)2 | b)3 |
|---|---|---|---|
| Specific gravity @ 20° C. | 1.174 | 1.164 | 1.136 |
| Viscosity @ 25° C., cSt | 49 | 57 | 93 |
| Refractive index, n_{D}²⁵ | 1.553 | 1.550 | 1.546 |
| Phosphorus content, wt % | 8.3 | 8.1 | 7.7 |
| Average molecular weight | 350 | 380 | 400 |
| Boiling point, ° C. | 415 | 423 | 435 |
| Flash point, ° C. (Cleveland open cup) | 237 | 237 | 237 |
| Acidity, mg KOH | <0.05 | <0.05 | <0.05 |
| Free phenols, wt % | <0.05 | <0.05 | <0.05 |

Another preferred group of phosphate ester(s) are liquid tertiary butylated triphenyl phosphates. Preferred compounds of this type have phosphorus contents in the range of about 6 to about 9 wt %.

A large number of various phosphate ester(s) suitable for use in the practice of this invention are available from a number of commercial suppliers.

The relative proportions of N-methyl-N-(2-hydroxyethyl)-p-toluidine and/or N,N-bis(2-hydroxyethyl)-p-toluidine (component a)), and phosphate ester(s), (component b)), can vary from an a):b) weight ratio of about 99:1 to about 50.1:49:9 as long as the amount of phosphate ester(s) in the mixture constitutes a minor solids-suppressing amount. In this connection, the term “minor solids-suppressing amount” means that the amount of component b), which is less than 50 wt % of the combined weight of components a) and b), is at least sufficient to (i) produce a measurable depression in the temperature at which the mixture of components a) and b) begins to form solids as compared to the temperature at which a sample of the same batch of component a) by itself begins to form solids and/or (ii) prolong the period of time during which the mixture of components a) and b) remains free of solids while at room temperature (e.g., around 23° C.) as compared to the period of time during which a sample of the same batch of component a) by itself remains free of solids at the same room temperature. The amount of component b) that will constitute a minor solids-suppressing amount will vary depending upon the makeup of components a) and b) being used, the particular extent of solids suppression desired, the temperatures to which the composition will be exposed, and the amount and identity of other components, if any, used in forming the composition. Thus in any case where the precise amounts of given components a) and b) in a given composition for achieving suitable solids suppression has not already been established, use of a few simple preliminary laboratory tests can be utilized. Although a major amount of component a) of about 99 wt % and a minor amount of component b) of about 1 wt % may provide a suitable solids suppression, it is more desirable to use major amounts of component a) of up to about 97 or 98 wt % and minor amounts of component b) of at least about 2 to 3 wt %. Suitable proportions of components a) and b), especially in the absence of additional components added to the liquid cure promoter composition, are a):b) weight ratios in the range of about 96:4 to about 80:20. Preferred proportions utilize components a) and b) in weight ratios in the range of about 95:5 to about 90:10.

To form the compositions of this invention the components thereof are mixed together in any suitable manner typically using suitable mixing apparatus such as a blending tank or vessel equipped with suitable agitation or stirring means.

In the event that prior to mixing component b) therewith, component a) is in solid form or is in the form of a liquid in which some of component a) has changed into solids, component a) should be heated to a mild temperature (e.g., in the range of 45 to 50° C. to transform component a) back into a solids-free liquid. Similarly, if after a period of time, a composition formed from components a) and b) has undergone solids formation, the composition should be heated to a mild temperature (e.g., in the range of 35 to 45° C. to transform the mixture into a solids-free liquid. As an example, this invention provides a method wherein a composition is formed from components a) and b) and is stored and/or transported at about 23° C. without solids formation occurring for at least 96 hours after:
1) component a) has been produced;
2) component a) has been heated to convert solids thereof into the liquid state by heating; or
3) the composition has been heated to convert solids therein into the liquid state by heating.

Among various embodiments of this invention are the following:

AA) A cure promoter composition with suppressed solids forming tendencies, which composition is formed from components which prior to use in forming the composition are comprised of:
a) a major amount of N-methyl-N-(2-hydroxyethyl)-p-toluidine or N,N-bis(2-hydroxyethyl)-p-toluidine, or both; and
b) a minor solids formation suppressing amount of at least one liquid fully-esterified phosphate ester having at least two, and preferably three, aryl ester groups and one or two phosphorus atoms in the molecule.

AB) A composition as in AA) wherein said major amount is up to 99 wt % and wherein said minor amount is at least 1 wt %.

AC) A composition as in AA) wherein said major amount is up to about 95 wt % and wherein said minor amount is at least about 5 wt %.

AD) A composition as in AA) wherein said major amount is in the range of about 90 to about 95 w% and wherein said minor amount is in the range of about 10 to about 5 w%.

AE) A composition as in any of AA)-AD) wherein component a) that is used in forming said composition is N-methyl-N-(2-hydroxyethyl)-p-toluidine.

AF) A composition as in any of AA)-AD) wherein component a) that is used in forming said composition is N,N-bis(2-hydroxyethyl)-p-toluidine.

AG) A composition as in any of AA)-AD) wherein component a) that is used in forming said composition is a mixture of N-methyl-N-(2-hydroxyethyl)-p-toluidine and N,N-bis(2-hydroxyethyl)-p-toluidine.

AH) A composition as in any of AA)-AD) wherein component b) that is used in forming said composition comprises:
(A) at least one phosphate ester having one phosphorus atom per molecule and either two aryl ester groups and one alkyl ester group per molecule or three aryl ester groups per molecule;
(B) at least one phosphate ester having two phosphorus atoms per molecule and either 4 aryl ester groups and one arylene diester group per molecule or 6 aryl ester groups per molecule; or
(C) both of (A) and (B).

AI) A composition as in any of AA)-AD) wherein component b) that is used in forming said composition comprises at least one isopropylated triphenyl phosphate.

AJ) A composition as in AD) wherein component a) that is used in forming said composition is N-methyl-N-(2-hydroxyethyl)-p-toluidine and wherein component b) that is used in forming said composition comprises at least one isopropylated triphenyl phosphate.

AK) A composition as in AD) wherein component a) that is used in forming said composition is N,N-bis(2-hydroxyethyl)-p-toluidine and wherein component b) that is used in forming said composition comprises at least one isopropylated triphenyl phosphate.

AL) In a method for curing crosslinkable unsaturated polymer resins with a peroxide initiator in the presence of at least a promoter, the improvement which comprises using as a component in forming the crosslinkable formulation, a cure promoter composition as in any of AA)-AD).

AM) The improvement according to AL) wherein component b) that is used in forming said cure promoter composition comprises:
(A) at least one phosphate ester having one phosphorus atom per molecule and either two aryl ester groups and one alkyl ester group per molecule or three aryl ester groups per molecule;
(B) at least one phosphate ester having two phosphorus atoms per molecule and either 4 aryl ester groups and one arylene diester group per molecule or 6 aryl ester groups per molecule; or
(C) both of (A) and (B).

AN) The improvement according to AL) wherein component a) that is used in forming said cure promoter composition is N-methyl-N-(2-hydroxyethyl)-p-toluidine and wherein component b) that is used in forming said cure promoter composition comprises at least one isopropylated triphenyl phosphate.

AO) The improvement according to AL) wherein component a) that is used in forming said cure promoter composition is N,N-bis(2-hydroxyethyl)-p-toluidine and wherein component b) that is used in forming said cure promoter composition is comprises at least one isopropylated triphenyl phosphate.

AP) In a method of preparing a curable, pre-promoted unsaturated polymer resin system comprising combining (i) a vinyl ester resin comprising the reaction product of a polyepoxide and an ethylenically unsaturated carboxylic acid with (ii) a cure promoter to form a pre-promoted curable polymer system, the improvement which comprises using as cure promoter in preparing the curable, pre-promoted unsaturated polymer resin system, a cure promoter composition as in any of AA)-AD).

AQ) The improvement according to AP) wherein component b) that is used in forming said cure promoter composition comprises:
(A) at least one phosphate ester having one phosphorus atom per molecule and either two aryl ester groups and one alkyl ester group per molecule or three aryl ester groups per molecule;
(B) at least one phosphate ester having two phosphorus atoms per molecule and either 4 aryl ester groups and one arylene diester group per molecule or 6 aryl ester groups per molecule; or
(C) both of (A) and (B).

AR) The improvement according to AP) wherein component a) that is used in forming said cure promoter composition is N-methyl-N-(2-hydroxyethyl)-p-toluidine and wherein component b) that is used in forming said cure promoter composition comprises at least one isopropylated triphenyl phosphate.

AS) The improvement according to AP) wherein component a) that is used in forming said cure promoter composition is N,N-bis(2-hydroxyethyl)-p-toluidine and wherein component b) that is used in forming said cure promoter composition comprises at least one isopropylated triphenyl phosphate.

AT) In a method for bonding a curing crosslinkable composition to a surface of a substrate wherein a crosslinkable composition comprised of a crosslinkable unsaturated polymer resin, a peroxide initiator, and a cure promoter is applied to said surface and the composition is cured, the improvement which comprises using as a cure promoter in forming the crosslinkable composition, a cure promoter composition as in any of AA)-AD).

AU) The improvement according to AT) wherein component b) that is used in forming said cure promoter composition comprises:
(A) at least one phosphate ester having one phosphorus atom per molecule and either two aryl ester groups and one alkyl ester group per molecule or three aryl ester groups per molecule;
(B) at least one phosphate ester having two phosphorus atoms per molecule and either 4 aryl ester groups and one arylene diester group per molecule or 6 aryl ester groups per molecule; or
(C) both of (A) and (B).

AV) The improvement according to AT) wherein component a) that is used in forming said cure promoter composition is N-methyl-N-(2-hydroxyethyl)-p-toluidine and wherein component b) that is used in forming said cure promoter composition comprises at least one isopropylated triphenyl phosphate.

AW) The improvement according to AT) wherein component a) that is used in forming said cure promoter composition is N,N-bis(2-hydroxyethyl)-p-toluidine and wherein component b) that is used in forming said cure promoter composition comprises at least one isopropylated triphenyl phosphate.

AX) A method of suppressing the solids forming tendencies of N-methyl-N-(2-hydroxyethyl)-p-toluidine or N,N-bis(2-hydroxyethyl)-p-toluidine, or both during storage or transportation, which method comprises:

I) forming a composition comprised of:
a) a major amount of N-methyl-N-(2-hydroxyethyl)-p-toluidine or N,N-bis(2-hydroxyethyl)-p-toluidine, or both; and
b) a minor solids formation suppressing amount of at least one liquid fully-esterified phosphate ester having at least two, and preferably three, aryl ester groups and one or two phosphorus atoms in the molecule; and

II) storing or transporting said composition.

AY) A method as in AX) wherein component b) that is used in forming said cure promoter composition is composed of at least a major amount of
(A) at least one phosphate ester having one phosphorus atom per molecule and either two aryl ester groups and one alkyl ester group per molecule or three aryl ester groups per molecule;
(B) at least one phosphate ester having two phosphorus atoms per molecule and either 4 aryl ester groups and one arylene diester group per molecule or 6 aryl ester groups per molecule; or
(C) both of (A) and (B).

AZ) A method as in AX) wherein said major amount is up to 99 wt % and wherein said minor amount is at least 1 wt %.

BA) A method as in AX) wherein said major amount is up to about 95 wt % and wherein said minor amount is at least about 5 wt %.

BB) A method as in AX) wherein components a) and b) are in proportions such that the a):b) weight ratio is in the range of about 96:4 to about 80:20.

BC) A method as in AX) wherein components a) and b) are in proportions such that the a):b) weight ratio is in the range of about 95:5 to about 90:10.

BD) A method as in any of AX)-BC) wherein component a) that is used in forming said composition is N-methyl-N-(2-hydroxyethyl)-p-toluidine.

BE) A method as in any of AX)-BC) wherein said composition is stored and/or transported at about 23° C. without solids formation occurring for at least 96 hours after (1) component a) has been produced; (2) component a) has been heated to convert solids thereof into the liquid state by heating; or (3) the composition has been heated to convert solids therein into the liquid state by heating.

BF) A method as in any of AX)-BC) wherein component a) that is used in forming said composition is N,N-bis(2-hydroxyethyl)-p-toluidine.

BG) A method as in BF) wherein said composition is stored and/or transported at about 23° C. without solids formation occurring for at least 96 hours after (1) component a) has been produced; (2) component a) has been heated to convert solids thereof into the liquid state by heating; or (3) the composition has been heated to convert solids therein into the liquid state by heating.

BH) A method as in any of AX)-BC) wherein component a) that is used in forming said composition is a mixture of N-methyl-N-(2-hydroxyethyl)-p-toluidine and N,N-bis(2-hydroxyethyl)-p-toluidine.

BI) A method as in BH) wherein said composition is stored and/or transported at about 23° C. without solids formation occurring for at least 96 hours after (1) component a) has been produced; (2) component a) has been heated to convert solids thereof into the liquid state by heating; or (3) the composition has been heated to convert solids therein into the liquid state by heating.

BJ) A method as in BH) wherein component b) that is used in forming said composition is comprises at least one isopropylated triphenyl phosphate.

BK) A method as in BH) wherein component a) that is used in forming said composition is N-methyl-N-(2-hydroxyethyl)-p-toluidine and wherein component b) that is used in forming said composition comprises at least one isopropylated triphenyl phosphate.

BL) A method as in BH) wherein component a) that is used in forming said composition is N,N-bis(2-hydroxyethyl)-p-toluidine and wherein component b) that is used in forming said composition comprises at least one isopropylated triphenyl phosphate.

Additional components may be included in a solids-free liquid cure promoter compositions of this invention in forming compositions which remain solids-free. In this case, care should be exercised in selecting one or more additional components which do not adversely affect the reduced temperature liquidity of the original composition or the solids forming tendencies of the original composition in any material way. Such selections can readily be made in any doubtful case by conducting a few simple tests. Alternatively, the solids-free liquid cure promoter compositions of this invention may be combined with additional components in forming solids-containing liquid compositions.

Non-limiting examples of additional components which may be used as described above include unsaturated polymer resins such as one or more of those described in U.S. Pat. Nos. 6,114,470; 6,258,894; or 6,774,193, common inert organic solvents, other cure promoters such as tertiary aromatic amines, suitably soluble organic metal salts, or mixtures of such amines and metal salts. A few examples of such tertiary aromatic include, without limitation, N,N-dimethylaniline, N,N-diethylaniline, N-ethyl-N-methylaniline, N,N-dimethyl-p-toluidine, N,N-bis(2-hydroxyethyl)-m-toluidine, and mixtures of any two or more such amines. A few non-limiting examples of suitable metal salt promoters that may be included include cobalt, vanadium, zirconium, iron, manganese, chromium, tin, aluminum, lead, or copper salts of such organic acids as one or more C₆₋₂₀ carboxylic acids, benzoic acid, or naphthenic acid. Mixtures of such salts can also be included as additional components of the liquid cure promoter compositions of this invention.

When additional components such as those referred to above are included in the liquid cure promoter compositions of this invention, the amounts of the components can be in the range of about 50.1 to about 99 wt % of component a), in the range of about 1 to about 49.9 wt % of component b), and the balance, if any, to 100 wt % being one or more additional components. More desirably, the proportions are in the range of about 50.1 to about 97 or 98 wt % of component a), in the range of about 2 or 3 wt % to about 49.9 wt % of component b), and the balance, if any, to 100 wt % being one or more additional components. Preferably these proportions are in the range of about 50.1 to about 80 wt % of component a), in the range of about 4 to about 20 wt % of component b), and the balance, if any, to 100 wt % being one or more additional components. More preferably these proportions are in the range of about 50.1 to about 90 wt % of component a), in the range of about 5 to about 10 wt % of component b), and the balance, if any, to 100 wt % being one or more additional components.

By virtue of the wider range of temperatures at which the liquid cure promoter compositions of this invention can be stored, handled, or used without solids formation occurring in the compositions, this invention also provides a variety of improved processing operations in which they are used. A first such improvement is in a method as fully described in U.S. Pat. No. 6,258,894 for curing crosslinkable unsaturated polymer resins with a peroxide initiator in the presence of a promoter. This first improvement pursuant to this invention comprises conducting the methods described in that patent using as cure promoter in forming the crosslinkable formulation, a solids-free liquid cure promoter composition of this invention as described in the specification and/or claims hereof. One preferred embodiment of this invention is that of the foregoing first improvement wherein component a) that is used in forming such liquid cure promoter composition is N-methyl-N-(2-hydroxyethyl)-p-toluidine and wherein component b) that is used in forming the liquid cure promoter composition has an average molecular weight in the range of about 360 to about 500 and a viscosity at 25° C. in the range of about 52 to about 100 cSt. Another preferred embodiment of this invention is that of the foregoing first improvement wherein component a) that is used in forming said liquid cure promoter composition is N,N-bis(2-hydroxyethyl)-p-toluidine and wherein component b) that is used in forming the liquid cure promoter composition has an average molecular weight in the range of about 300 to about 500 and a viscosity at 25° C. in the range of about 40 to about 100 cSt.

A second improvement is in a method as fully described in U.S. Pat. No. 6,774,193 of preparing a curable, pre-promoted unsaturated polymer resin system comprising combining (i) a vinyl ester resin comprising the reaction product of a polyepoxide and an ethylenically unsaturated carboxylic acid with (ii) a cure promoter to form a pre-promoted curable polymer system. This second improvement pursuant to this invention comprises conducting the methods as described in that patent using as cure promoter in preparing the curable, pre-promoted unsaturated polymer resin system, a solids-free liquid cure promoter composition of this invention as described in the specification and/or claims hereof. One preferred embodiment of this invention is that of the foregoing second improvement wherein component a) that is used in forming said liquid cure promoter composition is N-methyl-N-(2-hydroxyethyl)-p-toluidine and wherein component b) that is used in forming the liquid cure promoter composition has an average molecular weight in the range of about 360 to about 500 and a viscosity at 25° C. in the range of about 52 to about 100 cSt. Another preferred embodiment of this invention is that of the foregoing second improvement wherein component a) that is used in forming said liquid cure promoter composition is N,N-bis(2-hydroxyethyl)-p-toluidine and wherein component b) that is used in forming said liquid cure promoter composition has an average molecular weight in the range of about 300 to about 500 and a viscosity at 25° C. in the range of about 40 to about 100 cSt.

A third improvement is in a method as fully described in U.S. Pat. No. 6,114,470 for bonding a curing crosslinkable composition to a surface of a substrate wherein a crosslinkable composition comprised of a crosslinkable unsaturated polymer resin, a peroxide initiator, and a cure promoter is applied to such surface and the composition is cured. This third improvement pursuant to this invention comprises using as cure promoter in forming the crosslinkable composition, a solids-free liquid cure promoter composition of this invention as described in the specification and/or claims hereof. One preferred embodiment of this invention is that of the foregoing third improvement wherein component a) that is used in forming the liquid cure promoter composition is N-methyl-N-(2-hydroxyethyl)-p-toluidine and wherein component b) that is used in forming said liquid cure promoter composition has an average molecular weight in the range of about 360 to about 500 and a viscosity at 25° C. in the range of about 52 to about 100 cSt. Another preferred embodiment of this invention is that of the foregoing third improvement wherein component a) that is used in forming said liquid cure promoter composition is N,N-bis(2-hydroxyethyl)-p-toluidine and wherein component b) that is used in forming said liquid cure promoter composition is isopropylated triphenyl phosphate having an average molecular weight in the range of about 300 to about 500 and a viscosity at 25° C. in the range of about 40 to about 100 cSt.

In addition to lowering the temperatures at which the foregoing improved processing operations can be carried out using N-methyl-N-(2-hydroxyethyl)-p-toluidine or N,N-bis(2-hydroxyethyl)-p-toluidine, or both without incurring solids formation, and thereby broadening the operating temperature ranges over which these cure promoters can be effectively used, this invention provides still other benefits. For example, from the experimental results presented in Example 3 hereinafter, it is deemed likely that over a suitable use concentration range, liquid cure promoter compositions of this invention formed from components a) and b) should have about the same reactivity as equal concentrations of the same neat cure promoter. Also, from the experimental results presented in Example 4 hereinafter, it is deemed likely that the compositions of this invention formed from components a) and b) should have about the same stability in uncured unsaturated polyester formulations as equal concentrations of the same neat cure promoter.

The following Examples are illustrative of the practice and advantages of this invention. These Examples are not intended to limit, and should not be construed as limiting, this invention to only what is described therein.

### EXAMPLE 1

Several liquid cure promoter compositions of this invention composed solely of components a) and b) were prepared by blending the components together in specified proportions and with stirring at ambient room temperature. Separate portions of each initially solids-free, visually clear composition of this invention were held at specified temperatures for known periods of time and observed for appearance of solids. Component a) in these evaluations was in each case N-methyl-N-(2-hydroxyethyl)-p-toluidine (MHPT) which was solids-free at the start of the evaluations. Component b) in these evaluations were each of several isopropylated triphenyl phosphates used individually in the respective liquid cure promoter compositions of this invention. The isopropylated triphenyl phosphates used in these evaluations were samples of the products identified as b)1, b)2, or b)3 in Table 1. The makeup of the compositions tested are summarized in Table 2. Table 3 summarizes the results obtained.

TABLE 2

| | | Inventive | Inventive | Inventive |
|---|---|---|---|---|
| | Control | Composition | Composition | Composition |
| Component(s) | Sample | 1 | 2 | 3 |
| a) | 100% | 95 wt % | 95 wt % | 95 wt % |
| b)1 | none | 5 wt % | None | none |
| b)2 | none | none | 5 wt % | none |
| b)3 | none | none | | 5 wt % |

TABLE 3

| Sample | Results Obtained |
|---|---|
| Control | At 55° F. (ca. 13.3° C.) solids appeared overnight |
| | (i.e., within ca. 12 hours) |
| Inventive | After 3 days at 30° F. (ca. −1° C.) solids appeared |
| Composition 1 | |
| Inventive | After 3 days at 30° F. (ca. −1° C.) solids appeared; |
| Composition 2 | at 25° F. (ca. −4° C.) solids appeared overnight |
| | (i.e., within ca. 12 hours) |
| Inventive | After 4 days at 30° F. (ca. −1° C.) no solids appeared; |
| Composition 3 | after 3 days at 20° F. (ca. −6.5° C.) no solids appeared; |
| | at 12° F. (ca. −11° C.) solids appeared overnight |
| | (i.e., within ca. 12 hours) |

### EXAMPLE 2

The procedure of Example 1 was repeated except that Component a) in these evaluations was in each case N,N-bis(2-hydroxyethyl)-p-toluidine which was solids-free at the start of the evaluations. The makeup of the compositions tested are summarized in Table 4, and Table 5 summarizes the results obtained. In Table 4, component(s) b)1, b)2, and b)3 are as identified in Table 1.

TABLE 4

| | | Inventive | Inventive | Inventive |
|---|---|---|---|---|
| | Control | Composition | Composition | Composition |
| Component(s) | Sample | 4 | 5 | 6 |
| a) | 100% | 95 wt % | 95 wt % | 95 wt % |
| b)1 | none | 5 wt % | None | none |
| b)2 | none | none | 5 wt % | none |
| b)3 | none | none | | 5 wt % |

TABLE 5

| Sample | Results Obtained |
|---|---|
| Control | At 74° F. (23° C.) solids appeared within 12 hours |
| Inventive | After 3 days at 32° F. (0° C.) no solids appeared |
| Composition 4 | |
| Inventive | After 3 days at 32° F. (0° C.) no solids appeared |
| Composition 5 | |
| Inventive | After 3 days at 32° F. (0° C.) no solids appeared |
| Composition 6 | |

### EXAMPLE 3

In order to compare the gel times of curable formulations made with component a) with or without use of component b), 10 curable compositions were prepared and tested. The formulations used in these tests were made as follows: First, a blend 90 wt % of an unsaturated polyester resin (Aropol 7221H; Ashland Specialty Chemicals) and 10 wt % of methyl methacrylate was formed. To portions of this blend the promoters were added in various ratios (for ratios, see Table 6 below). Added to and mixed with each portion of the cure promoter-containing blend was 4 wt %, based on the weight of the polyester resin, of a paste made from equal amounts by weight of benzyl peroxide and isopropylated phenyl phosphate (Antiblaze® 519, Albemarle Corporation). Each resultant formulation was continuously mixed at a standard rate allowed to cure at 23° C., and the time from forming the formulation with mixing until the resin gelled was measured. Thus gel time was the time measured in seconds from mixing the paste of benzyl peroxide and cure promoter into the resin to the time of gel formation. Five of the formulations were made pursuant to this invention where the cure promoter in the paste was Inventive Composition 1 (a 95:5 composition formed from N-methyl-N-(2-hydroxyethyl)-p-toluidine (MHPT) and isopropylated triphenyl phosphate (b)1). The other five formulations were made using neat MHPT. The respective 10 formulations were compared at MHPT concentration levels of 0.1, 0.2, 0.3, 0.4, and 0.5 wt % based on the total weights of the formulations. Results of these runs are summarized in Table 6.

TABLE 6

| Gel Times Using Neat | |
|---|---|
| N-methyl-N- | Gel Times Using |
| (2-hydroxyethyl)-p-toluidine | Inventive Composition 1 |
| At 0.1 wt % MHPT, 272 seconds | At 0.1 wt % MHPT, 359 seconds |
| At 0.2 wt % MHPT, 153 seconds | At 0.2 wt % MHPT, 161 seconds |
| At 0.3 wt % MHPT, 126 seconds | At 0.3 wt % MHPT, 107 seconds |
| At 0.4 wt % MHPT, 103 seconds | At 0.4 wt % MHPT, 93 seconds |
| At 0.5 wt % MHPT, 72 seconds | At 0.5 wt % MHPT, 70 seconds |

From the results in Table 6 it may be concluded that the cure promoter compositions of this invention had essentially the same cure promoter activity as neat MHPT, at least over the range tested.

### EXAMPLE 4

Three unsaturated polymer resin systems were formed and their viscosities were determined before and after storage at 40° C. for two weeks. The systems used in these evaluations were (A) a cure promoter-free formulation of 90 wt % an unsaturated polyepoxide (Aropol 7221H; Ashland Specialty Chemicals) and 10 wt % of methyl methacrylate; (B) a combination of the formulation of (A) and 0.5 wt % of neat MHPT based on the total weight of the combination; and (C) a combination of the formulation of (A) and 0.5 wt % of MHPT in Inventive Composition 3 (see Table 2), this wt % value being based on the total weight of combination (C). Table 7 summarizes the results of these evaluations.

TABLE 7

| | | | |
|---|---|---|---|
| Initial Viscosity, cSt | 1263 | 12148 | 1240 |
| Final Viscosity, cSt | 2075 | 2117 | 2033 |

From the results in Table 7 it was concluded that the cure promoter composition of this invention would not cause any stability problems in unsaturated polyester formulations.

It is to be understood that the ingredients referred to by chemical name or formula anywhere in the specification or claims hereof, whether referred to in the singular or plural, are identified as they exist prior to coming into contact with another substance referred to by chemical name or chemical type (e.g., another reactant, a solvent, a diluent, or etc.). It matters not what preliminary chemical changes, transformations and/or reactions, if any, take place in the resulting mixture or solution or reaction medium as such changes, transformations and/or reactions are the natural result of bringing the specified reactants and/or components together under the conditions called for pursuant to this disclosure. Thus the reactants and other materials are identified as ingredients to be brought together in connection with performing a desired chemical reaction or in forming a mixture to be used in conducting a desired reaction. Also, even though the claims hereinafter may refer to substances, components and/or ingredients in the present tense (“comprises”, “is”, etc.), the reference is to the substance or ingredient as it existed at the time just before it was first contacted, blended or mixed with one or more other substances or ingredients in accordance with the present disclosure. The fact that the substance or ingredient may have lost its original identity through a chemical reaction or transformation or complex formation or assumption of some other chemical form during the course of such contacting, blending or mixing operations, is thus wholly immaterial for an accurate understanding and appreciation of this disclosure and the claims thereof. Nor does reference to an ingredient by chemical name or formula exclude the possibility that during the desired reaction itself an ingredient becomes transformed to one or more transitory intermediates that actually enter into or otherwise participate in the reaction. In short, no representation is made or is to be inferred that the named ingredients must participate in the reaction while in their original chemical composition, structure or form.

Each and every patent or other publication or published document referred to in any portion of this specification is incorporated in toto into this disclosure by reference, as if fully set forth herein.

Except as may be expressly otherwise indicated, the article “a” or “an” if and as used herein is not intended to limit, and should not be construed as limiting, a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove. Rather, what is intended to be covered is as set forth in the ensuing claims and the equivalents thereof.

That which is claimed is:

1. A cure promoter composition with suppressed solids forming tendencies, which composition is formed from components which prior to use in forming the composition are comprised of:
a) a major amount of N-methyl-N-(2-hydroxyethyl)-p-toluidine or N,N-bis(2-hydroxyethyl)-p-toluidine, or both; and
b) a minor solids formation suppressing amount of at least one liquid fully-esterified phosphate ester having at least two aryl ester groups and one or two phosphorus atoms in the molecule.

2. A composition as in claim 1 wherein said major amount is up to 99 wt % and wherein said minor amount is at least 1 wt %.

3. A composition as in claim 1 wherein said major amount is up to about 95 wt % and wherein said minor amount is at least about 5 wt %.

4. A composition as in claim 1 wherein component b) that is used in forming said composition comprises a triaryl phosphate having a phosphorus content in the range of about 6.5 to about 9.5 wt %.

5. A composition as in any of claims 1-4 wherein component b) that is used in forming said composition is:
i) a phosphate ester of the formula, (ArO)ₓP(O)(OR)_{y}, where each Ar is independently an aryl group, each R is independently an aryl or alkyl group, and x is 1-3 and y is 0-2, the sum of x and y being 3; or
ii) a phosphate ester of the formula, (ArO)₂P(O)(ORO)P(O)(OAr)₂, wherein each Ar is independently an aryl group, and R is an arylene group.

6. A composition as in any of claims 1-4 wherein component b) that is used in forming said composition comprises at least one isopropylated triphenyl phosphate.

7. In a method for curing crosslinkable unsaturated polymer resins with a peroxide initiator in the presence of at least a promoter, the improvement which comprises utilizing as a component in forming the crosslinkable formulation, a cure promoter composition formed from components which prior to use in forming the composition are comprised of:
a) a major amount of N-methyl-N-(2-hydroxyethyl)-p-toluidine or N,N-bis(2-hydroxyethyl)-p-toluidine, or both; and
b) a minor solids formation suppressing amount of at least one liquid fully-esterified phosphate ester having at least two aryl ester groups and one or two phosphorus atoms in the molecule.

8. The improvement according to claim 7 wherein component b) that is used in forming said cure promoter composition comprises:
i) a phosphate ester of the formula, (ArO)ₓP(O)(OR)_{y}, where each Ar is independently an aryl group, each R is independently an aryl or alkyl group, and x is 1-3 and y is 0-2, the sum of x and y being 3; or
ii) a phosphate ester of the formula, (ArO)₂P(O)(ORO)P(O)(OAr)₂, wherein each Ar is independently an aryl group, and R is an arylene group.

9. The improvement according to claim 7 wherein component b) that is used in forming said cure promoter composition comprises at least one isopropylated triphenyl phosphate.

10. In a method of preparing a curable, pre-promoted unsaturated polymer resin system comprising combining (i) a vinyl ester resin comprising the reaction product of a polyepoxide and an ethylenically unsaturated carboxylic acid with (ii) a cure promoter to form a pre-promoted curable polymer system, the improvement which comprises utilizing as cure promoter in preparing the curable, pre-promoted unsaturated polymer resin system, a cure promoter composition formed from components which prior to use in forming the composition are comprised of:
a) a major amount of N-methyl-N-(2-hydroxyethyl)-p-toluidine or N,N-bis(2-hydroxyethyl)-p-toluidine, or both; and
b) a minor solids formation suppressing amount of at least one liquid fully-esterified phosphate ester having at least two aryl ester groups and one or two phosphorus atoms in the molecule.

11. The improvement according to claim 10 wherein component b) that is used in forming said cure promoter composition comprises:
i) a phosphate ester of the formula, (ArO)ₓP(O)(OR)_{y}, where each Ar is independently an aryl group, each R is independently an aryl or alkyl group, and x is 1-3 and y is 0-2, the sum of x and y being 3; or
ii) a phosphate ester of the formula, (ArO)₂P(O)(ORO)P(O)(OAr)₂, wherein each Ar is independently an aryl group, and R is an arylene group.

12. The improvement according to claim 10 wherein component b) that is used in forming said cure promoter composition comprises at least one isopropylated triphenyl phosphate.

13. In a method for bonding a curing crosslinkable composition to a surface of a substrate wherein a crosslinkable composition comprised of a crosslinkable unsaturated polymer resin, a peroxide initiator, and a cure promoter is applied to said surface and the composition is cured, the improvement which comprises utilizing as a cure promoter in forming the crosslinkable composition, a cure promoter composition formed from components which prior to use in forming the composition are comprised of:
a) a major amount of N-methyl-N-(2-hydroxyethyl)-p-toluidine or N,N-bis(2-hydroxyethyl)-p-toluidine, or both; and
b) a minor solids formation suppressing amount of at least one liquid fully-esterified phosphate ester having at least two aryl ester groups and one or two phosphorus atoms in the molecule.

14. The improvement according to claim 13 wherein component b) that is used in forming said cure promoter composition comprises:
i) a phosphate ester of the formula, (ArO)ₓP(O)(OR)_{y}, where each Ar is independently an aryl group, each R is independently an aryl or alkyl group, and x is 1-3 and y is 0-2, the sum of x and y being 3; or
ii) a phosphate ester of the formula, (ArO)₂P(O)(ORO)P(O)(OAr)₂, wherein each Ar is independently an aryl group, and R is an arylene group.

15. The improvement according to claim 13 wherein component b) that is used in forming said cure promoter composition comprises at least one isopropylated triphenyl phosphate.

16. The improvement as in any of claims 7, 10, or 13 wherein said major amount is up to 99 wt % and wherein said minor amount is at least 1 wt %.

17. The improvement as in any of claims 7, 10, or 13 wherein said major amount is up to about 95 wt % and wherein said minor amount is at least about 5 wt %.

18. A method of suppressing the solids forming tendencies of N-methyl-N-(2-hydroxyethyl)-p-toluidine or N,N-bis(2-hydroxyethyl)-p-toluidine, or both during storage or transportation, which method comprises:
I) forming a composition comprised of:
a) a major amount of N-methyl-N-(2-hydroxyethyl)-p-toluidine or N,N-bis(2-hydroxyethyl)-p-toluidine, or both; and
b) a minor solids formation suppressing amount of at least one liquid fully-esterified phosphate ester having at least two aryl ester groups and one or two phosphorus atoms in the molecule; and
II) storing or transporting said composition.

19. A method as in claim 18 wherein component b) that is used in forming said composition is comprised of:
i) a phosphate ester of the formula, (ArO)ₓP(O)(OR)_{y}, where each Ar is independently an aryl group, each R is independently an aryl or alkyl group, and x is 1-3 and y is 0-2, the sum of x and y being 3; or
ii) a phosphate ester of the formula, (ArO)₂P(O)(ORO)P(O)(OAr)₂, wherein each Ar is independently an aryl group, and R is an arylene group.

20. A method as in claim 18 wherein component b) that is used in forming said composition is comprised of at least one isopropylated triphenyl phosphate.

21. A method as in claim 18 wherein said major amount is up to 99 wt % and wherein said minor amount is at least 1 wt %.

22. A method as in claim 18 wherein said major amount is up to about 95 wt % and wherein said minor amount is at least about 5 wt %.

23. A method as in claim 18 wherein components a) and b) are in proportions such that the a):b) weight ratio is in the range of about 96:4 to about 80:20.

24. A method as in claim 18 wherein components a) and b) are in proportions such that the a):b) weight ratio is in the range of about 95:5 to about 90:10.

25. A method as in any of claims 18-20 wherein component a) that is used in forming said composition is N-methyl-N-(2-hydroxyethyl)-p-toluidine.

26. A method as in claim 18 wherein said composition is stored and/or transported at about 23° C. without solids formation occurring for at least 96 hours after (1) component a) has been produced; (2) component a) has been heated to convert solids thereof into the liquid state by heating; or (3) the composition has been heated to convert solids therein into the liquid state by heating.
